(19) United States
(12) Patent Application Publication
(10) Pub. No.: US 2025/0384853 A1
(43) Pub. Date: Dec. 18, 2025

(54) DISPLAY METHOD, DISPLAY APPARATUS AND COMPUTER-READABLE STORAGE MEDIUM

(71) Applicant: HKC CORPORATION LIMITED, Shenzhen (CN)

(72) Inventors: Peidi Huang, Shenzhen (CN); Haijiang Yuan, Shenzhen (CN)

(21) Appl. No.: 19/237,056

(22) Filed: Jun. 13, 2025

(30) Foreign Application Priority Data
Jun. 17, 2024 (CN) 202410775975.5

(51) Int. Cl. G09G 3/34; G02B 26/00; G02F 1/16755; G02F 1/16766; G02F 1/1685

(52) U.S. Cl. CPC G09G 3/348; G02B 26/005; G02F 1/16755; G02F 1/16766; G02F 1/1685; G02B 2207/115; G09G 2300/0842; G09G 2310/0267; G09G 2310/0275; G09G 2330/021

(57) ABSTRACT

This application is applicable to the field of display technology, and provides a display method, a display apparatus and a computer-readable storage medium, which are applied to a display apparatus, including: acquiring position information of a target content in a pixel electrode array; charging target pixel electrodes corresponding with each of coordinate point positions in the position information respectively until reaching a target voltage matching each of the target pixel electrodes; based on the target voltage matching each of the target pixel electrodes, controlling discrete droplets in the display apparatus to move to the coordinate point positions corresponding with each of the target pixel electrodes respectively; and powering off each of the target pixel electrodes, obtaining the target content indicated by the discrete droplets and displaying it. In this way, the accurate presentation of the content displayed by the discrete droplets can be ensured.

### CROSS-REFERENCE TO RELATED APPLICATIONS

The present application claims priority to Chinese patent application No. 202410775975.5, filed on Jun. 17, 2024 and entitled “Display method, display apparatus and computer-readable storage medium”, which is incorporated herein by reference in its entirety.

### TECHNICAL FIELD

The present application relates to the technical field of display technology, and more specifically, to a display method, a display apparatus and a computer-readable storage medium.

### BACKGROUND

With continual development of the display industry, display screens are used in more and more scenarios, while market demands for display screens are also constantly changing.

For a smart display price tag scenario, in the related art, electronic paper technology is usually used to implement corresponding display screens. However, since electronic paper products have a feature of self-fading, there may be sticking images and fading of displayed contents during use, resulting in reduced accuracy of the contents presented on display products.

### SUMMARY

In view of this, embodiments of the present application provide a display method, a display apparatus and a computer-readable storage medium, which can accurately present content displayed by discrete droplets.

In the first aspect, a display method is provided in the embodiments of the present application, which is applied to a display apparatus, including a pixel electrode array composed of a plurality of pixel electrodes, where the method includes:
acquiring position information of a target content in the pixel electrode array;
charging target pixel electrodes corresponding with each of the coordinate point positions in the position information respectively until reaching a target voltage matching each of the target pixel electrodes;
controlling discrete droplets in the display apparatus to move to the coordinate point positions corresponding with each of the target pixel electrodes respectively, based on the target voltage matching each of the target pixel electrodes; and
powering off each of the target pixel electrodes, displaying the target content indicated by the discrete droplets.

In an implementation mode of the first aspect, where the charging target pixel electrodes corresponding with each of the coordinate point positions in the position information respectively until reaching a target voltage matching each of the target pixel electrodes includes:
determining a driving circuit associated with the target pixel electrodes at each of the coordinate point positions in the position information respectively;
for each of the target pixel electrodes, under the condition that the driving circuit associated with the target pixel electrodes is in the on state, charging the target pixel electrodes to an intermediate voltage based on a source driver associated with the driving circuit associated with the target pixel electrodes; and
charging the target pixel electrodes from the intermediate voltage to the target voltage based on a power supply voltage associated with the driving circuit.

In an implementation mode of the first aspect, where the driving circuit includes: a gate driver and the source driver associated with the target pixel electrodes, a gate line associated with the gate driver, and a data line, a first transistor, a second transistor, a third transistor, a target pixel electrode and a storage capacitor which are associated with the source driver;
where the for each of the target pixel electrodes, under the condition that the driving circuit associated with the target pixel electrodes is in an on state, charging the target pixel electrodes to an intermediate voltage based on a source driver associated with the driving circuit associated with the target pixel electrodes includes:
providing, by the gate driver, a scanning signal to the first transistor and the second transistor through the gate line to turn on the first transistor and the second transistor;
providing, by the source driver, a data signal to the second transistor through the first transistor in the on state based on the data line to turn on the second transistor;
charging, by the source driver, the target pixel electrodes to the intermediate voltage through the first transistor and the third transistor in the on state; and
where the charging the target pixel electrodes from the intermediate voltage to the target voltage based on a power supply voltage associated with the driving circuit includes:
charging, by the power supply voltage, the target pixel electrodes from the intermediate voltage to the target voltage through the second transistor in the on state;
maintaining, the storage capacitor, the target voltage of the target pixel electrodes within a target time period.

In an implementation mode of the first aspect, where the display apparatus further includes a droplet replacement area, the droplet replacement area is configured with a droplet replacement hole, and the method further includes:
receiving a droplet replacement instruction, and controlling all the discrete droplets in the display apparatus to move toward a bottom of the display apparatus through a first power supply mode;
controlling discrete droplets at the bottom of the display apparatus to move toward the droplet replacement area through a second power supply mode until all the discrete droplets are located in the droplet replacement area; and
extracting droplets in the droplet replacement area and injecting new droplets through the droplet replacement hole.

In an implementation mode of the first aspect,
where the receiving a droplet replacement instruction, and controlling all the discrete droplets in the display apparatus to move toward bottom of the display apparatus through a first power supply mode includes:
receiving the droplet replacement instruction, applying voltage row by row to electrodes in an electrode sequence along the direction from a top to the bottom of the display apparatus to control all the discrete droplets in the display apparatus to move to the bottom of the display apparatus;
where the controlling the discrete droplets at the bottom of the display apparatus to move toward the droplet replacement area through a second power supply mode until all the discrete droplets are located in the droplet replacement area includes:
applying voltage column by column to electrodes in the electrode sequence along the direction from the bottom of the display apparatus to the droplet replacement area to control the discrete droplets at the bottom of the display apparatus to move to the droplet replacement area until all the discrete droplets are located in the droplet replacement area.

In an implementation mode of the first aspect, where the method further includes:
acquiring an interval power-on cycle for each of the target pixel electrodes;
determining the latest power-on time point for the target pixel electrodes, and determining a time interval between the power-on time point and a current time point; and
powering each of the target pixel electrodes periodically based on an association relationship between the time interval and the interval power-on cycle.

In an implementation mode of the first aspect, where the controlling discrete droplets in the display apparatus to move to the coordinate point positions corresponding with each of the target pixel electrodes respectively, based on the target voltage matching each of the target pixel electrodes includes:
for each of the target pixel electrodes, adjusting an interfacial contact angle of the discrete droplets on the side of the target pixel electrodes based on the target voltage matching each of the target pixel electrodes; and
controlling the discrete droplets to move to the coordinate point positions corresponding to the target pixel electrodes based on a relationship between an adjusted interfacial contact angle and the target voltage.

In the second aspect, a display device is provided in the embodiments of the present application, which is deployed in a display apparatus, and the display apparatus includes a pixel electrode array composed of a plurality of pixel electrodes, and the device includes:
an acquisition module, used to acquire position information of a target content in the pixel electrode array;
a charging module, used to charge target pixel electrodes corresponding with each of the coordinate point positions in the position information respectively until reaching a target voltage matching each of the target pixel electrodes;
a control module, used to control discrete droplets in the display apparatus to move to the coordinate point positions corresponding with each of the target pixel electrodes respectively, based on the target voltage matching each of the target pixel electrodes; and
a display module, used to power off each of the target pixel electrodes, and to obtain the target content indicated by the discrete droplets and to display it.

In the third aspect, a display apparatus is provided in the embodiments of the present application, and the display apparatus including a memory, a processor, and a computer program stored in the memory and executable on the processor, where the processor is configured to execute the computer program to implement steps of the method according to the first aspect.

In the fourth aspect, a computer-readable storage medium is provided in the embodiments of the present application, and the computer-readable storage medium stores a computer program, where the computer program is executed by a processor to implement steps of the method according to the first aspect.

The beneficial effect of the first aspect of embodiments of the present application is: in the display apparatus including the pixel electrode array, the target pixel electrodes are quickly determined by acquiring precise position information of the target content in the pixel electrode array. Then, the target pixel electrodes are charged to the target voltage, and the discrete droplets in the display apparatus are precisely controlled to move to each specified coordinate point position based on the target voltage. Finally, the target content indicated by the discrete droplets is stably displayed in the display apparatus through power-off processing. In this way, precise control of the discrete droplets is achieved through precise positioning for the pixel electrodes and independent control for pixel electrodes, thereby ensuring the accurate presentation of content displayed using the discrete droplets.

It can be understood that the beneficial effects of the second to fourth aspects mentioned above can be referred to the relevant description in the first aspect mentioned above, and are not described herein again.

### BRIEF DESCRIPTION OF DRAWINGS

In order to more clearly illustrate the technical solutions in embodiments of the present application, drawings used in description of the embodiments or prior art are briefly introduced below. Obviously, the drawings described below are only some embodiments of the present application. For a person of ordinary skill in the art, other drawings can also be obtained based on these drawings without creative efforts.

FIG. 1 is a schematic diagram of a structure of a display apparatus provided in Embodiment 1 of the present application;

FIG. 2 is a schematic diagram of an implementation process of a display method provided in Embodiment 2 of the present application;

FIG. 3 is an example diagram of a corresponding relationship between coordinate point positions provided in Embodiment 2 of the present application;

FIG. 4 is an example diagram of position information of displayed contents provided in Embodiment 2 of the present application;

FIG. 5 is an example diagram of a pixel driving circuit provided in Embodiment 2 of the present application;

FIG. 6 is a schematic diagram of an implementation process of a charging method of a pixel electrode provided in Embodiment 3 of the present application;

FIG. 7 is an example diagram of another pixel driving circuit provided in Embodiment 4 of the present application;

FIG. 8 is a schematic diagram of controlling movements of discrete droplets provided in Embodiment 5 of the present application;

FIG. 9 is a schematic diagram of a replacement process of discrete droplets provided in Embodiment 7 of the present application;

FIG. 10 is a schematic diagram of an implementation process of a display method of a digital price tag provided in Embodiment 9 of the present application;

FIG. 11 is a schematic diagram of a display device provided in the embodiments of the present application;

FIG. 12 is a schematic diagram of a display apparatus provided in the embodiments of the present application;

### REFERENCE NUMBERS

upper substrate—110;
lower substrate—120;
electrode layer—130, pixel electrode—131;
transistor layer—140;
first hydrophobic layer—160;
second hydrophobic layer—170;
droplet layer—180, discrete droplets—181.

### DESCRIPTION OF EMBODIMENTS

In the following description, for the purpose of explanation rather than limitation, specific details such as specific system structures and technologies are proposed so as to provide a thorough understanding of the embodiments of the present application. However, it should be clear to those skilled in the art that the present application can also be implemented in other embodiments without these specific details. In other cases, detailed descriptions of well-known systems, devices, circuits, and methods are omitted to avoid unnecessary details that hinder the description of the present application.

It should be understood that when used in the present application specification and the appended claims, the term “includes” indicates the presence of the described features, wholes, steps, operations, elements, and/or components, but does not exclude the presence or addition of one or more other features, wholes, steps, operations, elements, components, and/or their collections.

It should also be understood that the term “and/or” used in the present application specification and the appended claims refers to any combination of one or more of the associated listed items and all possible combinations, and includes these combinations.

As used in the specification of the present application and the appended claims, the term “if” can be interpreted as “when . . . ” or “once” or “in response to determination” or “in response to detection” depending on the context. Similarly, the phrase “if it is determined” or “if [the described condition or event] is detected” can be interpreted as meaning “once it is determined” or “in response to determination” or “once [the described condition or event] is detected” or “in response to detection [the described condition or event]” depending on the context.

In addition, in the description of the specification of the present application and the appended claims, the terms “first”, “second”, “third”, etc. are only used to distinguish the description and cannot be understood as indicating or implying relative importance.

The reference to “one embodiment” or “some embodiments” etc. described in the specification of the present application means that one or more embodiments of the present application include specific features, structures or characteristics described in conjunction with the embodiment. Therefore, the sentences “in one embodiment”, “in some embodiments”, “in some other embodiments”, “in some other embodiments”, etc. appearing in different places in the present application do not necessarily refer to the same embodiment, but mean “one or more but not all embodiments”, unless otherwise specifically emphasized in other ways. The terms “include”, “comprising”, “having” and variations thereof all mean “including but not limited to”, unless specifically emphasized otherwise.

### Embodiment 1

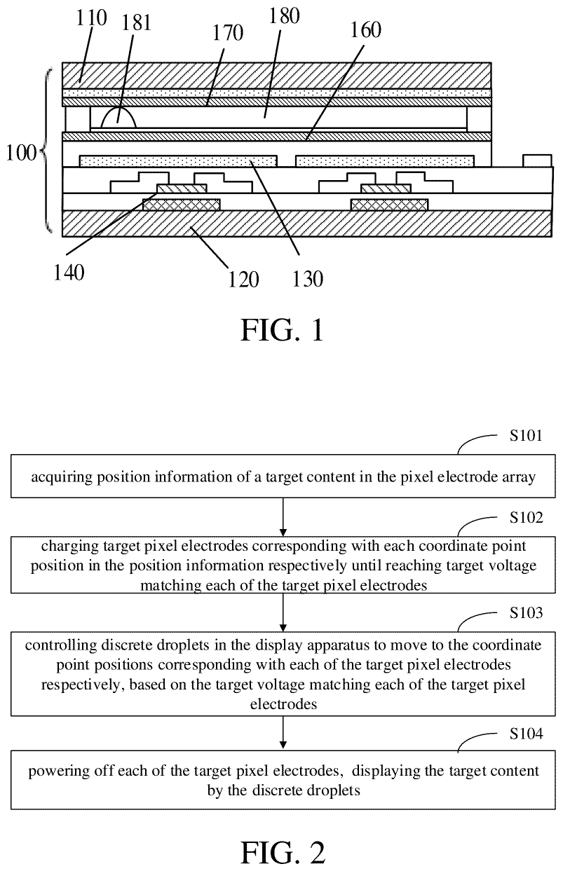

As shown in FIG. 1, a display apparatus is provided in the embodiment 1 of the present application. The display apparatus 100 includes at least an upper substrate 110 and a lower substrate 120; a pixel electrode array is arranged on a side of the lower substrate away from the upper substrate to form an electrode layer 130; a transistor layer 140 is arranged on the same layer as the electrode layer 130 on a side of the lower substrate close to the upper substrate; a first hydrophobic layer 160 is laid on a side of the electrode layer 130 away from the lower substrate, and the first hydrophobic layer is used to isolate discrete droplets from the electrode layer to ensure smooth movement of discrete droplets; a second hydrophobic layer 170 is arranged on a side of the upper substrate 110 close to the first hydrophobic layer 160; and the discrete droplets 181 are filled between the first hydrophobic layer and the second hydrophobic layer to form a droplet layer 180.

In application, each pixel electrode in the pixel electrode array can be independently controlled, and the pixel electrode is usually made of a transparent conductive material (such as indium tin oxide ITO). It should be noted that in order to ensure the movement of the droplets and to reduce friction resistance as much as possible, silicone oil can be added between the hydrophobic layer and the droplets to reduce friction.

In the application, the specific form of the display apparatus can be a mobile phone, a tablet computer, a wearable device, a vehicle-mounted device, an augmented reality (AR)/virtual reality (VR) device, a laptop computer, an ultra-mobile personal computer (UMPC), a netbook, a personal digital assistant (PDA), a billboard, an information display board and other electronic devices. Embodiments of the present application does not impose any restrictions on the specific type of the display apparatus.

### Embodiment 2

As shown in FIG. 2, a display method provided in Embodiment 2 of the present application is applied to a display apparatus 100, and includes the following steps:

In a step S101, position information of a target content is acquired in the pixel electrode array.

In the step S101, the target content refers to a content that needs to be displayed using discrete droplets stored in the display apparatus. The pixel electrode array is usually represented as an m×n matrix, where m and n are both positive integers. The position information refers to the coordinate point positions of the target content in a two-dimensional coordinate system corresponding to the pixel electrode array.

The way for acquiring the position information is described below. A control program for the display apparatus is acquired. The control program is deployed in a terminal device connected to the display apparatus. The terminal device displays a control screen, including a two-dimensional canvas. A coordinate system corresponding to the two-dimensional canvas is consistent with a coordinate system corresponding to the pixel electrode array. That is, the coordinate point positions in the two-dimensional canvas correspond one-to-one with the coordinate point position s in the pixel electrode array. That is, the control screen is also an m×n matrix, and the matrix points in the control screen and those in the pixel electrode array are uniquely located using a x, y coordinate system.

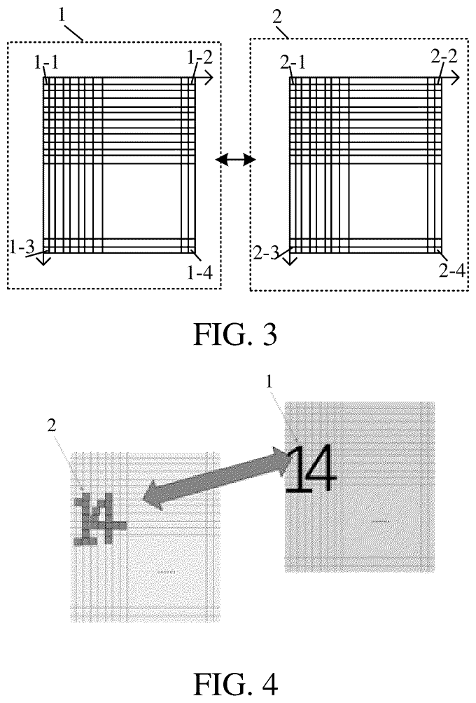

In the application, as shown in FIG. 3, number 1 in the figure is the matrix points of the two-dimensional canvas in the control program, number 1-1 in the figure represents a coordinate point position (1,1), number 1-2 in the figure represents a coordinate point position (n, 1), number 1-3 in the figure represents a coordinate point position (1,m), and number 1-4 in the figure represents a coordinate point position (m,n). In the figure, number 2 is the coordinate point positions in the pixel electrode array, number 2-1 in the figure represents a coordinate point position (1,1), number 2-2 in the figure represents a coordinate point position (n, 1), number 2-4 in the figure represents a coordinate point position (1,m), and number 2-4 in the figure represents a coordinate point position (m,n). The coordinate point positions in the two correspond one-to-one.

In the application, an operator inputs the target content (i.e., the content to be displayed) in the two-dimensional canvas of the terminal device connected to the display apparatus, and determines the position information of the target content in the two-dimensional canvas, and the position information is a plurality of coordinate point positions. In response to a display request for the target content, a display instruction carrying the position information of the target content is sent by the terminal device to the display apparatus. The display instruction is parsed by the display apparatus, and the position information of the target content is read by the display apparatus from the display instruction to acquire the position information of the target content relative to the pixel electrode array. It should be noted that since the matrix points in the two-dimensional canvas are corresponded one-to-one with the matrix points in the pixel electrode array, the position information of the target content in the two-dimensional canvas is consistent with the matrix points of the target content in the pixel electrode array.

In the application, as shown in FIG. 4, number 1 in the figure shows the position information of the target content in the two-dimensional canvas in the control program (including a plurality of coordinate point positions). Number 2 in the figure shows the position information of the target content in the pixel electrode array (coordinate point positions corresponding one-to-one with those in the two-dimensional canvas) determined according to the position information of number 1.

In a step S102, target pixel electrodes are charged corresponding with each of the coordinate point positions in the position information respectively until reaching a target voltage matching each of the target pixel electrodes.

In the step S102, the target pixel electrodes are at least part of the pixel electrodes associated with the target content in the pixel electrode array.

In the application, in order to control the discrete droplets to move to each coordinate point position in the position information, the target pixel electrodes associated with each coordinate point position can be charged by the display apparatus independently, so that each of the target pixel electrodes is charged to the target voltage, thereby changing surfaces of the target pixel electrodes from hydrophobic to hydrophilic under action of an electric field, and generating a pressure difference in the relative direction of discrete droplets to control the discrete droplets in the display apparatus to move toward the target pixel electrodes.

In the application, the process of charging each pixel electrode by the display apparatus can be implemented based on a driving circuit associated with each pixel electrode, and the driving circuit associated with the pixel electrode can be called a pixel driving circuit. With the pixel electrode array arranged on a driving substrate, a gate driver is associated in the row direction and a source driver is associated in the column direction. A scan signal is sent by the gate driver and transmitted in the pixel driving circuit through the gate line to turn on a transistor in the pixel driving circuit. A data signal is sent by the source driver and transmitted in the pixel driving circuit through the data line. Each pixel driving circuit includes at least a gate driver, a source driver, one or more transistors, pixel electrodes, etc. The pixel electrodes can be charged by the display apparatus to a target voltage through the pixel driving circuit.

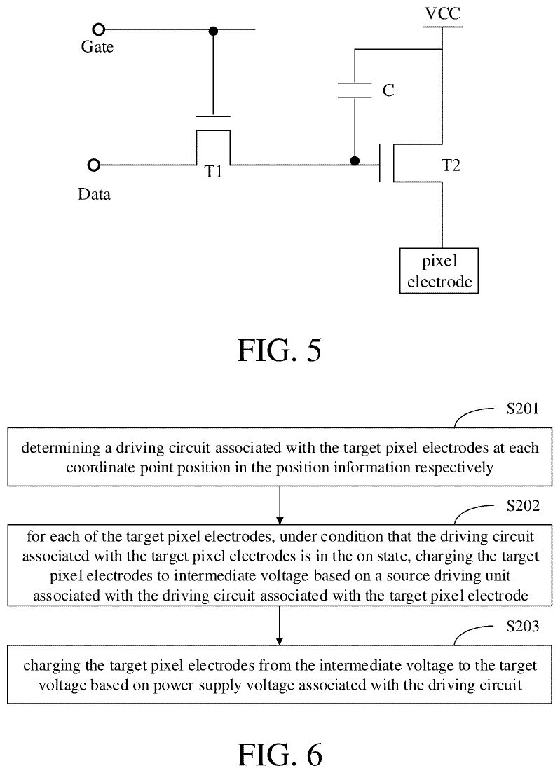

In the application, a charging operation for the pixel electrodes can be implemented based on the pixel driving circuit shown in FIG. 5. In the driving circuit, the gate driver (Gate) turns on a transistor T1, and the source driver (Data) turns on a transistor T2 through the transistor T1 in the on state. The magnitude of voltage of the Data determines a degree of turn-on of the transistor T2. At the same time, the power supply (VCC) supplies power to the pixel electrodes to charge the pixel electrodes to the target voltage so that the pixel electrode controls the movement of droplets.

In a step S103, discrete droplets are controlled in the display apparatus to move to the coordinate point positions corresponding with each of the target pixel electrodes respectively, based on the target voltage matching each of the target pixel electrodes.

In the step S103, the target voltage refers to voltage applied to the target pixel electrodes, which can stabilize the discrete droplets at the coordinate point positions corresponding to the target pixel electrodes.

In the application, a control principle for the discrete droplets is to control surface tension of the droplets by using the driving circuit, so as to realize behaviors of the droplets, such as movement, breakup, etc. Controlling surface tension of the droplets by using the driving circuit is essentially to use the electrowetting phenomenon on the surface of the droplets to change solid-liquid surface tension of a dielectric layer by applying voltage to the target pixel electrodes, thereby changing a contact angle of the droplets on a side of a powered electrode, and realizing flexible movement of the droplets on the plane. The contact angle refers to an angle between the droplets and the hydrophobic layer, also known as a solid-liquid contact angle. Controlling the movement of the droplets actually continuously adjusts the size of the contact angle.

In a step S104, each of the target pixel electrodes are powered off, the target content indicated by the discrete droplets is obtained and displayed.

In the application, when there are discrete droplets on the target pixel electrodes and the discrete droplets are no longer moving, the target pixel electrodes are performed on a power-off process by the display apparatus in a power-on state, which can increase the service life of the display apparatus. Combined with the pixel driving circuit, after the target pixel electrode is powered off, the storage capacitor can continue to be used to power the pixel electrodes to maintain stability of the discrete droplets.

In this embodiment, the target pixel electrodes are quickly determined by obtaining precise position information of the target content in the pixel electrode array. Then, the target pixel electrode is charged to the target voltage, the discrete droplets in the display apparatus are precisely controlled to move to each designated coordinate point position based on the target voltage. Finally, the target content indicated by the discrete droplets is stably displayed in the display apparatus through the power-off processing. In this way, precise control of the discrete droplets is achieved through precise locating for pixel electrodes and independent control for pixel electrodes, thereby ensuring accurate presentation of the content displayed by the discrete droplets.

### Embodiment 3

As shown in FIG. 6, in this embodiment, target pixel electrodes associated with each of the coordinate point positions in the position information are charged by a display apparatus respectively until reaching target voltage matching each of the target pixel electrodes, including the following steps:

In a step S201, determining a driving circuit associated with the target pixel electrodes at each of the coordinate point positions in the position information respectively.

In a step S202, for each of the target pixel electrodes, under the condition that the driving circuit associated with the target pixel electrode is in the on state, the target pixel electrodes are charged to an intermediate voltage based on a source driver associated with the driving circuit associated with the target pixel electrodes.

In a step S203, the target pixel electrodes are charged from the intermediate voltage to the target voltage based on a power supply voltage associated with the driving circuit.

In the application, each pixel electrode is associated with a driving circuit. For the pixel electrode to be charged, in addition to using a driving circuit shown in FIG. 5 to directly charge the pixel electrode from zero to the target voltage through VCC, the pixel voltage can also be charged to an intermediate voltage through a voltage initialization operation, and then charged to the target voltage from the intermediate voltage through VCC. Among them, the voltage initialization operation is implemented by the source driver associated with the driving circuit.

In this embodiment, on condition that the driving circuit is turned on, the target pixel electrodes are charged to the intermediate voltage, and then charged from the intermediate voltage to the target voltage. This step-by-step charging way can optimize a charging process, reduce current fluctuations and power consumption during the charging process, and improve charging efficiency of the target pixel electrode.

### Embodiment 4

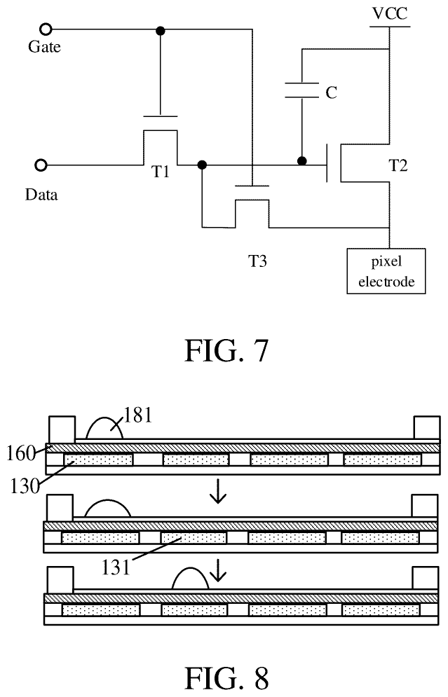

As shown in FIG. 7, a schematic diagram of a driving circuit is provided in Embodiment 4 of the present application. The driving circuit includes at least a gate driver (Gate) and a source driver (Data) associated with a target pixel electrode, a gate line associated with the gate driver, a data line associated with the source driver, a first transistor T1, a second transistor T2, a third transistor T3, a target pixel electrode, and a storage capacitor C;
where a scanning signal is provided by the gate driver to the first transistor and the second transistor through the gate line to turn on the first transistor and the second transistor; a data signal is provided by the source driver to the second transistor through the first transistor in the on state based on the data line to turn on the second transistor; the target pixel electrode is charged by the source driver to an intermediate voltage through the first transistor and the third transistor in the on state; the target pixel electrode is charged by a power supply voltage from the intermediate voltage to target voltage through the second transistor in the on state; and the storage capacitor is used to maintain the target voltage of the target pixel electrode within the target time period.

In application, the gate driver is supplied power to by the display apparatus through a driving substrate, and the first transistor T1 and the third transistor T3 are turned on by the gate driver through the gate line at the same time, and then the second transistor T2 is turned on by the source driver through the first transistor T1 in the on state through the data line, and at the same time, firstly voltage of the third transistor T3 is initialized by the source driver, so that the intermediate voltage V1 is applied by the source driver to the pixel electrode, and then the pixel electrode is charged by the source driver from V1 to the target voltage V2 through the power supply voltage (VCC).

In this embodiment, by applying voltage to the pixel electrode in advance, the pixel electrode can quickly reach a required voltage level when the power supply voltage (VCC) is supplying power, thereby increasing a movement velocity of droplets.

### Embodiment 5

Movement of discrete droplets can also be controlled by the display apparatus in the following way: for each of target pixel electrodes, contact angles of the discrete droplets on a side of the target pixel electrodes are adjusted based on target voltage matched to the target pixel electrodes; and based on a relationship between adjusted contact angles and the target voltage, the discrete droplets are controlled to move to the coordinate point positions corresponding to the target pixel electrodes.

In application, when a pixel electrode is powered on, due to an electrowetting effect, a surface of the electrode layer changes from hydrophobic to hydrophilic, and part of solid-liquid contact angles of the discrete droplets on a side of a powered electrode are going to decrease, while solid-liquid contact angles of the discrete droplets on the other side remains unchanged, so that the discrete droplets tends to move toward the side of the powered electrode; and a relationship between a solid-liquid interface contact angle and applied voltage, dielectric layer thickness, dielectric constant and other conditions is shown in formula (1):

$$cos θ = cos {θ}_{0} + \frac{{ε}_{0} {ε V}^{2}}{2 d {γ}_{L v}} \qquad formula ( 1 )$$

In the above formula (1), θ is a solid-liquid contact angle of discrete droplets when the applied voltage is V; θ₀ is an initial solid-liquid contact angle of the discrete droplets when the applied voltage is zero; d is the dielectric layer thickness; ε is a relative dielectric constant of a dielectric layer; γ_{Lv} is a gas-liquid interface tension coefficient, and ε₀ is a vacuum dielectric constant. Therefore, by controlling the pixel electrode on a driving substrate, the movement of the discrete droplets on the hydrophobic layer of the driving substrate can be controlled, and the position where the discrete droplets stay can be controlled.

As shown in FIG. 1, the discrete droplets are located between the first hydrophobic layer 160 and the second hydrophobic layer 170 of the display apparatus. When the pixel electrode is not powered, the discrete droplets 181 remain in a stable state. When an empty pixel electrode (e.g. a pixel electrode without discrete droplets) adjacent to the pixel electrode is charged, a solid-liquid contact angle of the discrete droplets close to a side of the charged electrode decreases, and the discrete droplets begin to move. After moving to target positions, the discrete droplets stop moving and remain stable after the charged electrode is stopped from being charged. Morphological changes of the discrete droplets are shown in FIG. 8. When the pixel electrode is not powered, the discrete droplets remain in a stable state. If the pixel electrode 131 in the electrode layer 130 is charged, a solid-liquid contact angle of the discrete droplets 181 begins to decrease, and the discrete droplets begin to move. When the discrete droplets move to the coordinate point positions indicated by the pixel electrode 131, the pixel electrode is stopped from being powered, and the discrete droplets stop moving and remain stable.

In this embodiment, by precisely controlling the voltage and the contact angle of the discrete droplets, the droplets can be precisely controlled without increasing extra energy consumption, which can reduce display errors caused by inaccurate droplet control and improve reliability of entire display system.

### Embodiment 6

A display apparatus is also configured with a droplet replacement area, and the droplet replacement area is configured with a droplet replacement hole. Based on this, the following operations can also be performed by the display apparatus: a droplet replacement instruction is received, and all the discrete droplets in the display apparatus are controlled to move toward a bottom of the display apparatus through a first power supply mode; discrete droplets at the bottom of the display apparatus are controlled to move toward the droplet replacement area through a second power supply mode until all the discrete droplets are located in the droplet replacement area; and through the droplet replacement hole, droplets in the droplet replacement area are extracted and new droplets are injected.

In the application, there is a droplet replacement demand for discrete droplets, such as replacing black and/or white discrete droplets with colored droplets, or replacing droplets of different materials. In order to meet the droplet replacement demand mentioned above, the display apparatus is also configured with a droplet replacement area, and a droplet replacement hole is provided in the droplet replacement area. Typically, the droplet replacement area is located on a side of a drive substrate, and the droplet replacement hole is located at bottom of the droplet replacement area. After receiving a droplet replacement instruction, the discrete droplets are first controlled by the display apparatus to move to bottom of the display apparatus through a first power supply mode. Then, the discrete droplets at the bottom are controlled to move to the droplet replacement area through a second power supply mode. Finally, a pump, a straw or other fluid processing device is used to remove old droplets and inject new droplets. Among them, the first power supply mode is a mode of supplying power row by row to the pixel electrode array, which circulates power row by row from the top of the display apparatus downward, so that the discrete droplets are moved to the bottom of the display apparatus. The second power supply mode is a mode of supplying power column by column to the pixel electrode array, and the discrete droplets at the bottom of the display apparatus are moved to the droplet replacement area.

In this embodiment, by receiving the droplet replacement instruction, display system can automatically execute the droplet replacement process, reducing the need for manual intervention and improving maintenance efficiency. Using different power supply modes to accurately control the movement of droplets in the display apparatus ensures that the droplets can accurately reach the specified position. By controlling the droplets to move toward the bottom and concentrate them in the droplet replacement area, all droplets can be easily replaced at one time, thereby improving replacement efficiency.

### Embodiment 7

The movement of discrete droplets is controlled by the display apparatus toward bottom of the display apparatus through a first power supply mode. The first power supply mode specifically refers to a power supply mode in which voltage is applied row by row to electrodes in an electrode sequence along a direction from top to the bottom of the display apparatus. The movement of discrete droplets at the bottom of the display apparatus is controlled toward a droplet replacement area through a second power supply mode. The second power supply mode specifically refers to a power supply mode in which voltage is applied column by column to electrodes in the electrode sequence along a direction from the bottom of the display apparatus to the droplet replacement area.

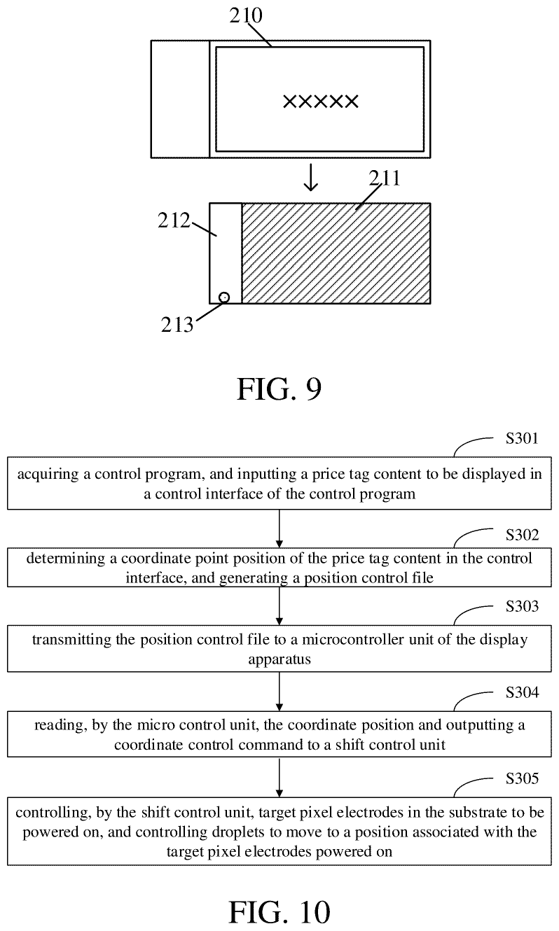

In application, as shown in FIG. 9, a schematic diagram of a droplet replacement process is provided. A display apparatus 100 can be divided into a display area 210 and other areas. The display area 210 includes a substrate area 211 and a droplet replacement area 212. The droplet replacement area 212 is generally located on a side of the substrate area 211 (as shown on the left side in the figure), and a droplet replacement hole 213 is located at bottom of the droplet replacement area 212. When performing a droplet replacement operation, the pixel electrode array on the substrate carried by the substrate area is powered on row by row according to the first power supply mode to control the discrete droplets to move from the top to the bottom, so that all the discrete droplets move to the bottom. Then, according to the second power supply mode, the pixel electrode array is powered on column by column to control the droplets at the bottom to move to the droplet replacement area, and finally, the droplets are extracted from the droplet replacement hole and replaced with new droplets.

In the application, after the replacement of discrete droplets is completed, the display apparatus performs a reset operation and verifies whether the new droplets have been correctly filled into the display apparatus. The verification process may include visual inspection, capacity measurement or functional testing of the droplets to ensure that the display apparatus returns to normal working state.

In this embodiment, combined with the first power supply mode and the second power supply mode, on condition that the display apparatus receives a droplet replacement instruction, all discrete droplets can be controlled by the display apparatus to move quickly to the droplet replacement area, thereby improving efficiency of droplet replacement. The entire droplet replacement process realizes automated control from movement to replacement of droplets, which improves operational efficiency and accuracy.

### Embodiment 8

The following operations can also be performed by the display apparatus for the target pixel electrode: an interval power-on cycle is acquired for each of the target pixel electrodes; the last power-on time point is determined for the target pixel electrode, and a time interval between the power-on time point and the current time point is determined; and based on a correlation between the time interval and the interval power-on cycle, each of the target pixel electrodes is powered on periodically.

In applications, a display apparatus (such as a smart price tag display product, etc.) can be placed in a vertical direction when used. Under the action of gravity, discrete droplets may move by themselves after being placed for a long time. In order to ensure position stability of the discrete droplets, different ways of maintaining stability can be set according to the size of different display apparatus. For large-size display apparatus (display size greater than a size threshold), non-conductive silicone oil can be added to the hydrophobic layer where the discrete droplets are located, and the discrete droplets are placed in the silicone oil. The viscous wrapping of the silicone oil ensures that the droplets will not move downward by themselves in the hydrophobic layer due to gravity.

It should be noted that the position of the discrete droplets in the hydrophobic layer is actually very small, and the size of the droplets is in the micron to nanometer range. The intermolecular force will prevent the droplets from moving. However, when a single display screen remains unchanged, the discrete droplets may move under the action of gravity. For small-sized (display size is less than or equal to the size threshold) display apparatus (such as in smart price tag display scenarios), the hydrophobic layer of small-sized products has a smaller space, and the amount of droplets available for addition after adding silicone oil become less, which may result in insufficient droplets. Therefore, for the small-sized display products, in scenarios where display content does not need to change frequently, since the coordinate point positions of corresponding drive substrate is fixed after the display screen is determined. Thus, after display apparatus is powered off subsequent to the content is displayed, an intermittent power-on operation can effectively prevent the discrete droplets from moving automatically. Among them, the intermittent power-on operation is a process of periodically controlling the power-on of the pixel electrode. In order to realize the interval power-on operation, the display apparatus acquires a preset interval power-on cycle, determines the most recent power-on time point of each electrode, and then calculates a time interval between the current time point and the most recent power-on time point of the electrode. If the time interval reaches the preset interval power-on cycle, the power-on instruction is triggered to perform a next power-on operation for the electrode.

In this embodiment, through this periodic power-on way, these electrode coordinate point positions are powered on once every period of time, so that the droplets will not fall under the action of gravity for a long time, and display stability of discrete droplets is maintained. By accurately acquiring and recording the power-on cycle and the time point of each electrode, precise control of the power-on of the electrode can be achieved.

It should be noted that in the non-display field, a transparent glass substrate is usually used to control the movement of discrete droplets. In the display field, the transparent glass substrate can be replaced with a white-bottomed non-transparent glass substrate for high viewing clarity of the display content. In addition, dimmable glass can adjust transparency in the power-on state. Therefore, the glass substrate can be replaced with the dimmable glass according to personal preferences or specific scene requirements, thereby achieving better adaptability and personalized experience.

In this embodiment, the replaceability of the glass substrate constituting the driving substrate can better meet the diverse needs of users and improve users' experience.

### Embodiment 9

As shown in FIG. 10, a display method provided in Embodiment 9 of the present application is applicable to a display scenario of smart digital price tags in digital applications of commercial supermarkets. In this scenario, a target content to be displayed is a content of digital price tags, the display apparatus is a smart price tag display product, and the glass plate corresponding to the upper substrate and the lower substrate adopts a white-bottomed non-transparent glass substrate to ensure the clear display of the digital price tag. The display method of this embodiment includes the following steps:

In a step S301, a control program is acquired, and a price tag content to be displayed is inputted in a control interface of the control program.

In a step S302, a coordinate point position of the price tag content in the control interface is determined, and a position control file is generated.

In a step S303, the position control file is transmitted to a microcontroller unit of the display apparatus.

In a step S304, the coordinate point position is read by the microcontroller unit and a coordinate control command is outputted by the microcontroller unit to a shift control unit.

In a step S305, target pixel electrodes in the substrate are controlled by the shift control unit to be powered on, and droplets are controlled by the shift control unit to move to a position associated with the target pixel electrodes powered on.

In the application, in order to meet the display requirements of the digital price tag, a control program (or software) associated with the display apparatus is designed using a general programming language (such as C language). The software is run to display the control interface. The control interface includes a two-dimensional canvas with matrix point positions. A matrix associated with the control interface has a one-to-one correspondence with an electrode array of a driving substrate. Electrodes of the driving substrate and the matrix points in the control interface are individually located using the x, y coordinate system. When the digital price tag needs to be displayed, text contents or picture contents to be displayed on the price tag is inputted on the control interface of the control program, and these contents are placed in the matrix of the control interface. The control program determines positions of the price tag content in the matrix, and reads the coordinate point positions corresponding to these positions to form these coordinate point positions into the position control file. Subsequently, the position control file is output to a microcontroller unit (MCU) chip of the display apparatus, and the control command is transmitted to the shift control unit through the MCU. And then the target pixel electrodes in the substrate are controlled by the shift control unit to be powered off, and the droplets are controlled by the shift control unit to move to the coordinate point positions associated with the target pixel electrodes. After the droplets reaching the coordinate point positions, the content displayed by the droplets can be presented.

In this embodiment, by controlling the movement of the droplets to display the content of digital price tags, applications of digital price tags in commercial supermarkets are more extensive and diversified, and it can also effectively reduce power consumption and improve light transmittance.

A display device is also provided by the embodiments of the present application, the display device is implemented based on NAND flash memory and is used to execute steps in embodiments of the display method mentioned above. The display device can be a virtual appliance in a first terminal device, and the virtual appliance is run by a processor of the first terminal device, or it can be the first terminal device itself.

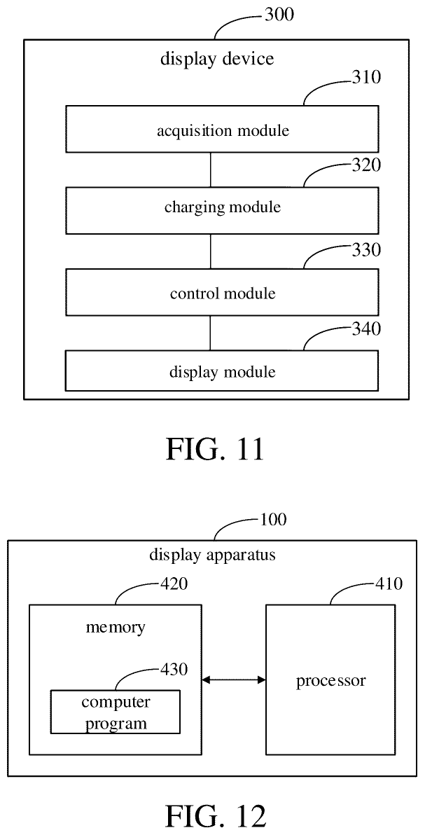

As shown in FIG. 11, a display device 300, as an example of the first terminal device, deployed in the display apparatus is provided in the embodiments of the present application, the display apparatus includes a pixel electrode array composed of a plurality of pixel electrodes, and the display device includes:

An acquisition module 310 is used to acquire position information of a target content in the pixel electrode array.

A charging module 320 is used to charge target pixel electrodes corresponding with each of the coordinate point positions in the position information respectively until reaching target voltage matching each of the target pixel electrodes.

A control module 330 is used to control discrete droplets in the display apparatus to move to the coordinate point positions corresponding with each of the target pixel electrodes respectively, based on the target voltage matching each of the target pixel electrodes.

A display module 340 is used to power off each of the target pixel electrodes, to obtain the target content indicated by the discrete droplets and to display it.

In one embodiment, the charging module is also used to determine a driving circuit associated with the target pixel electrode at each of the coordinate point positions in the position information respectively; for each of the target pixel electrodes, under the condition that the driving circuit associated with the target pixel electrode is in the on state, to charge the target pixel electrode to an intermediate voltage based on a source driver associated with the driving circuit associated with the target pixel electrode; and to charge the target pixel electrode from the intermediate voltage to the target voltage based on a power supply voltage associated with the driving circuit.

In one embodiment, the driving circuit includes: a gate driver and the source driver associated with the target pixel electrode, a gate line associated with the gate driver, and a data line, a first transistor, a second transistor, a third transistor, a target pixel electrode and a storage capacitor which are associated with the source driver; where: the gate driver provides a scanning signal to the first transistor and the second transistor through the gate line to turn on the first transistor and the second transistor; the source driver provides a data signal to the second transistor through the first transistor in the on state based on the data line to turn on the second transistor; the source driver charges the target pixel electrode to the intermediate voltage through the first transistor and the third transistor in the on state; the power supply voltage charges the target pixel electrode from the intermediate voltage to the target voltage through the second transistor in the on state; and the storage capacitor maintains the target voltage of the target pixel electrode within a target time period.

In one embodiment, the display apparatus further includes a droplet replacement area, the droplet replacement area is configured with a droplet replacement hole. The display module is also used to receive a droplet replacement instruction, and to control all the discrete droplets in the display apparatus to move toward a bottom of the display apparatus through a first power supply mode; to control discrete droplets at the bottom of the display apparatus to move toward the droplet replacement area through a second power supply mode until all the discrete droplets are located in the droplet replacement area; and to extract droplets in the droplet replacement area and to inject new droplets through the droplet replacement hole.

In one embodiment, for each of the target pixel electrodes, the control module is also used to adjust an interfacial contact angle of the discrete droplets on the side of the target pixel electrodes based on the target voltage matching each of the target pixel electrodes; and to control the discrete droplets to move to the coordinate point positions corresponding to the target pixel electrodes based on a relationship between an adjusted interfacial contact angle and the target voltage.

In one embodiment, the display module is also used to acquire an interval power-on cycle for each of the target pixel electrodes; to determine the latest power-on time point for the target pixel electrode, and to determine a time interval between the power-on time point and a current time point; and to power each of the target pixel electrodes periodically based on an association relationship between the time interval and the interval power-on cycle.

In one embodiment, the display apparatus also includes a lower substrate and an upper substrate; the pixel electrode array is configured on a side of the lower substrate away from the upper substrate to form an electrode layer; a transistor layer is arranged in the same layer as the electrode layer on a side of the lower substrate close to the upper substrate; a first hydrophobic layer is laid on a side of the electrode layer away from the lower substrate, and the first hydrophobic layer is used to isolate the discrete droplets from the electrode layer to ensure smooth movement of the discrete droplets; a second hydrophobic layer is configured on a side of the upper substrate close to the first hydrophobic layer; and the discrete droplets are filled between the first hydrophobic layer and the second hydrophobic layer to form a droplet layer.

In application, each module in the display apparatus can be a software program module, or can be implemented by different logic circuits integrated in the processor, or can be implemented by multiple distributed processors.

FIG. 12 is a schematic diagram of a structure of a display apparatus provided in the embodiments of the present application. As shown in FIG. 12, the display apparatus 100 of the embodiments include: at least one processor 410 (only one is shown in FIG. 12), a memory 420, and a computer program 430 stored in the memory 420 and executable on the at least one processor 410. The processor 410 is configured to execute the computer program 430 to implement steps in any of the display methods mentioned above. It can be understood by those skilled in the art that FIG. 12 is only an embodiment of the display apparatus 100 and does not constitute a limitation on the display apparatus 100. the display apparatus 100 can include more or less components than shown in the figure, or combine certain components in the figure, or combine components different from one or more components in the figure. For example, it can also include an input device and an output device, a network access device, etc.

The processor 410 can be a central processing unit (CPU), and the processor 410 can also be other general-purpose processors, digital signal processors (DSP), application specific integrated circuits (ASIC), field-programmable gate arrays (FPGA) or other programmable logic devices, discrete gates or transistor logic devices, discrete hardware components, etc. The general-purpose processors may be a microprocessor or the processor may be any conventional processor, etc.

The memory 420 may be an internal storage unit of the display apparatus 100 in some embodiments, such as a hard disk or memory of the display apparatus 100. The memory 420 may also be an external storage device of the display apparatus 100 in other embodiments, such as a plug-in hard disk, a smart media card (SMC), a secure digital (SD) card, a flash card, etc. equipped on the display apparatus 100. Further, the memory 420 may also include both an internal storage unit and an external storage device of the display apparatus 100. The memory 420 is used to store an operating system, an application, a bootloader, data, and other programs, such as the program code of the computer program. The memory 420 may also be used to temporarily store data that has been output or is to be output.

It should be noted that the information interaction, execution process, etc. between the above-mentioned devices/units are based on the same concept as the embodiments of the method of the present application. The specific functions and technical effects brought about by the above-mentioned devices/units can be specifically referred to the section of the embodiments of the method, and are not described herein again.

Technical personnel in the relevant field can clearly understand that for the convenience and simplicity of description, only the division of the above-mentioned functional units and modules is used as an embodiment for illustration. In actual applications, the above-mentioned functions can be assigned to different functional units and modules as needed, that is, the internal structure of the device can be divided into different functional units or modules to complete all or part of the functions described above. The functional units and modules in the embodiment can be integrated into a processing unit, or each unit can exist physically separately, or two or more units can be integrated into one unit. The above-mentioned integrated unit can be implemented in the form of hardware or in the form of software functional units. In addition, the specific names of the functional units and modules are only for the convenience of mutual distinction and are not used to limit the scope of protection of this application. The specific working process of the units and modules in the above-mentioned system can refer to the corresponding process in the above-mentioned method embodiment, and are not described herein again.

A computer-readable storage medium is provided in the embodiments of the present application, and the computer-readable storage medium stores a computer program, where the computer program is executed by a processor to implement steps in any of the display methods mentioned above.

A computer program product is provided in the embodiments of the present application, where the computer program product is executed by a mobile terminal to implement steps in any of the display methods mentioned above.

If the integrated unit is implemented in the form of a software functional unit and sold or used as an independent product, it can be stored in a computer-readable storage medium. Based on this understanding, the present application implements all or part of the processes in the above-mentioned embodiment method, which can be completed by instructing the relevant hardware through a computer program, and the computer program can be stored in a computer-readable storage medium, and the computer program can implement the steps of the above-mentioned method embodiments when executed by the processor. Among them, the computer program includes computer program code, and the computer program code can be in source code form, object code form, executable file or some intermediate form. The computer-readable medium may at least include: any entity or device that can carry the computer program code to the device/terminal device, recording medium, computer memory, read-only memory (ROM), random access memory (RAM), electric carrier signal, telecommunication signal and software distribution medium. For example, a USB flash drive, a mobile hard disk, a disk or an optical disk. In some jurisdictions, according to legislation and patent practice, computer-readable media cannot be electric carrier signals and telecommunication signals.

In the above embodiments, the description of each embodiment has its own emphasis. For parts that are not described or recorded in a certain embodiment, refer to the relevant description of other embodiments.

A person of ordinary skill in the art can realize that the units and algorithm steps of each example described in combination with the embodiments disclosed in this article can be implemented in electronic hardware, or a combination of computer software and electronic hardware. Whether these functions are executed in hardware or software depends on the specific application and design constraints of the technical solution. Professional technicians can use different methods to implement the described functions for each specific application, but such implementation should not be considered to be beyond the scope of this application.

In the embodiments provided in this application, it should be understood that the disclosed device/network equipment and method can be implemented in other ways. For example, the device/network equipment embodiments described above are only schematic. For example, the division of the modules or units is only a logical function division. There may be other division methods in actual implementation, such as a plurality of units or components can be combined or integrated into another system, or some features can be ignored or not executed. Another point is that the mutual coupling or direct coupling or communication connection shown or discussed may be an indirect coupling or communication connection through some interfaces, devices or units, which may be electrical, mechanical or other forms.

The units described as separate components may or may not be physically separated, and the components shown as units may or may not be physical units, that is, they may be located in one place, or they may be distributed on a plurality of network units. Some or all of the units may be selected according to actual needs to achieve the purpose of the scheme of this embodiment.

The above embodiments are only used to illustrate the technical scheme of the present application, not to limit it; although the present application is described in detail with reference to the above embodiments, ordinary technicians in this field should understand that they can still modify the technical schemes recorded in the above embodiments, or replace some of the technical features therein by equivalent; and these modifications or replacements do not make the essence of the corresponding technical schemes deviate from the spirit and scope of the technical schemes of the embodiments of the present application, and should be included in the scope of protection of the present application.

What is claimed is:

1. A display method, applied to a display apparatus, comprising a pixel electrode array composed of a plurality of pixel electrodes, wherein the method comprises:
acquiring position information of a target content in the pixel electrode array;
charging target pixel electrodes corresponding with each of coordinate point positions in the position information respectively until reaching a target voltage matching each of the target pixel electrodes;
controlling discrete droplets in the display apparatus to move to the coordinate point positions corresponding with each of the target pixel electrodes respectively, based on the target voltage matching each of the target pixel electrodes; and
powering off each of the target pixel electrodes, displaying the target content by the discrete droplets.

2. The display method according to claim 1, wherein the charging target pixel electrodes corresponding with each of the coordinate point positions in the position information respectively until reaching a target voltage matching each of the target pixel electrodes comprises:
determining a driving circuit associated with the target pixel electrodes at each of the coordinate point positions in the position information respectively;
for each of the target pixel electrodes, under the condition that the driving circuit associated with the target pixel electrodes is in the on state, charging the target pixel electrodes to an intermediate voltage based on a source driver associated with the driving circuit associated with the target pixel electrodes; and
charging the target pixel electrodes from the intermediate voltage to the target voltage based on a power supply voltage associated with the driving circuit.

3. The display method according to claim 2, wherein the driving circuit comprises: a gate driver and the source driver associated with the target pixel electrodes, a gate line associated with the gate driver, and a data line, a first transistor, a second transistor, a third transistor, a target pixel electrode and a storage capacitor which are associated with the source driver;
wherein the for each of the target pixel electrodes, under the condition that the driving circuit associated with the target pixel electrodes is in an on state, charging the target pixel electrodes to an intermediate voltage based on a source driver associated with the driving circuit associated with the target pixel electrodes comprises:
providing, by the gate driver, a scanning signal to the first transistor and the second transistor through the gate line to turn on the first transistor and the second transistor;
providing, by the source driver, a data signal to the second transistor through the first transistor in the on state based on the data line to turn on the second transistor;
charging, by the source driver, the target pixel electrodes to the intermediate voltage through the first transistor and the third transistor in the on state;
wherein the charging the target pixel electrodes from the intermediate voltage to the target voltage based on a power supply voltage associated with the driving circuit comprises:
charging, the power supply voltage, the target pixel electrodes from the intermediate voltage to the target voltage through the second transistor in the on state; and
maintaining, by the storage capacitor, the target voltage of the target pixel electrodes within a target time period.

4. The display method according to claim 1, wherein the display apparatus further comprises a droplet replacement area, the droplet replacement area is configured with a droplet replacement hole, and the method further comprises:
receiving a droplet replacement instruction, and controlling all the discrete droplets in the display apparatus to move toward a bottom of the display apparatus through a first power supply mode;
controlling discrete droplets at the bottom of the display apparatus to move toward the droplet replacement area through a second power supply mode until all the discrete droplets are located in the droplet replacement area; and
extracting droplets in the droplet replacement area and injecting new droplets through the droplet replacement hole.

5. The display method according to claim 4,
wherein the receiving a droplet replacement instruction, and controlling all the discrete droplets in the display apparatus to move toward a bottom of the display apparatus through a first power supply mode comprises:
receiving the droplet replacement instruction, applying voltage row by row to electrodes in an electrode sequence along a direction from a top to the bottom of the display apparatus to control all the discrete droplets in the display apparatus to move to the bottom of the display apparatus;
wherein the controlling the discrete droplets at the bottom of the display apparatus to move toward the droplet replacement area through a second power supply mode until all the discrete droplets are located in the droplet replacement area comprises:
applying voltage column by column to electrodes in the electrode sequence along a direction from the bottom of the display apparatus to the droplet replacement area to control the discrete droplets at the bottom of the display apparatus to move to the droplet replacement area until all the discrete droplets are located in the droplet replacement area.

6. The display method according to claim 1, wherein the method further comprises:
Acquiring an interval power-on cycle for each of the target pixel electrodes;
determining the latest power-on time point for the target pixel electrodes, and determining a time interval between the power-on time point and a current time point; and
powering each of the target pixel electrodes periodically based on an association relationship between the time interval and the interval power-on cycle.

7. The display method according to claim 1, wherein the controlling discrete droplets in the display apparatus to move to the coordinate point positions corresponding with each of the target pixel electrodes respectively, based on the target voltage matching each of the target pixel electrodes comprises:
for each of the target pixel electrodes, adjusting a contact angle of the discrete droplets on the side of the target pixel electrodes based on the target voltage matching each of the target pixel electrodes; and
controlling the discrete droplets to move to the coordinate point positions corresponding to the target pixel electrodes based on a relationship between an adjusted contact angle and the target voltage.

8. The display method according to claim 1, wherein the display apparatus further comprises a lower substrate and an upper substrate; wherein:
the pixel electrode array is configured on a side of the lower substrate away from the upper substrate to form an electrode layer; a transistor layer is arranged in the same layer as the electrode layer on a side of the lower substrate close to the upper substrate;
a first hydrophobic layer is laid on a side of the electrode layer away from the lower substrate, and the first hydrophobic layer is used to isolate the discrete droplets from the electrode layer to ensure smooth movement of the discrete droplets;
a second hydrophobic layer is configured on a side of the upper substrate close to the first hydrophobic layer; and
the discrete droplets are filled between the first hydrophobic layer and the second hydrophobic layer to form a droplet layer.

9. The display method according to claim 2, wherein the display apparatus further comprises a lower substrate and an upper substrate; wherein:
the pixel electrode array is configured on a side of the lower substrate away from the upper substrate to form an electrode layer; a transistor layer is arranged in the same layer as the electrode layer on a side of the lower substrate close to the upper substrate;
a first hydrophobic layer is laid on a side of the electrode layer away from the lower substrate, and the first hydrophobic layer is used to isolate the discrete droplets from the electrode layer to ensure smooth movement of the discrete droplets;
a second hydrophobic layer is configured on a side of the upper substrate close to the first hydrophobic layer; and
the discrete droplets are filled between the first hydrophobic layer and the second hydrophobic layer to form a droplet layer.

10. The display method according to claim 3, wherein the display apparatus further comprises a lower substrate and an upper substrate; wherein:
the pixel electrode array is configured on a side of the lower substrate away from the upper substrate to form an electrode layer; a transistor layer is arranged in the same layer as the electrode layer on a side of the lower substrate close to the upper substrate;
a first hydrophobic layer is laid on a side of the electrode layer away from the lower substrate, and the first hydrophobic layer is used to isolate the discrete droplets from the electrode layer to ensure smooth movement of the discrete droplets;
a second hydrophobic layer is configured on a side of the upper substrate close to the first hydrophobic layer; and
the discrete droplets are filled between the first hydrophobic layer and the second hydrophobic layer to form a droplet layer.

11. The display method according to claim 4, wherein the display apparatus further comprises a lower substrate and an upper substrate; wherein:
the pixel electrode array is configured on a side of the lower substrate away from the upper substrate to form an electrode layer; a transistor layer is arranged in the same layer as the electrode layer on a side of the lower substrate close to the upper substrate;
a first hydrophobic layer is laid on a side of the electrode layer away from the lower substrate, and the first hydrophobic layer is used to isolate the discrete droplets from the electrode layer to ensure smooth movement of the discrete droplets;
a second hydrophobic layer is configured on a side of the upper substrate close to the first hydrophobic layer; and
the discrete droplets are filled between the first hydrophobic layer and the second hydrophobic layer to form a droplet layer.

12. The display method according to claim 5, wherein the display apparatus further comprises a lower substrate and an upper substrate; wherein:
the pixel electrode array is configured on a side of the lower substrate away from the upper substrate to form an electrode layer; a transistor layer is arranged in the same layer as the electrode layer on a side of the lower substrate close to the upper substrate;
a first hydrophobic layer is laid on a side of the electrode layer away from the lower substrate, and the first hydrophobic layer is used to isolate the discrete droplets from the electrode layer to ensure smooth movement of the discrete droplets;
a second hydrophobic layer is configured on a side of the upper substrate close to the first hydrophobic layer; and
the discrete droplets are filled between the first hydrophobic layer and the second hydrophobic layer to form a droplet layer.

13. The display method according to claim 6, wherein the display apparatus further comprises a lower substrate and an upper substrate; wherein:
the pixel electrode array is configured on a side of the lower substrate away from the upper substrate to form an electrode layer; a transistor layer is arranged in the same layer as the electrode layer on a side of the lower substrate close to the upper substrate;
a first hydrophobic layer is laid on a side of the electrode layer away from the lower substrate, and the first hydrophobic layer is used to isolate the discrete droplets from the electrode layer to ensure smooth movement of the discrete droplets;
a second hydrophobic layer is configured on a side of the upper substrate close to the first hydrophobic layer; and
the discrete droplets are filled between the first hydrophobic layer and the second hydrophobic layer to form a droplet layer.

14. The display method according to claim 7, wherein the display apparatus further comprises a lower substrate and an upper substrate; wherein:
the pixel electrode array is configured on a side of the lower substrate away from the upper substrate to form an electrode layer; a transistor layer is arranged in the same layer as the electrode layer on a side of the lower substrate close to the upper substrate;
a first hydrophobic layer is laid on a side of the electrode layer away from the lower substrate, and the first hydrophobic layer is used to isolate the discrete droplets from the electrode layer to ensure smooth movement of the discrete droplets;
a second hydrophobic layer is configured on a side of the upper substrate close to the first hydrophobic layer; and
the discrete droplets are filled between the first hydrophobic layer and the second hydrophobic layer to form a droplet layer.

15. A display apparatus, comprising a memory, a processor, and a computer program stored in the memory and executable on the processor, wherein the processor is configured to execute the computer program to implement steps of the method according to claim 1.

16. A display apparatus, comprising a memory, a processor, and a computer program stored in the memory and executable on the processor, wherein the processor is configured to execute the computer program to implement steps of the method according to claim 2.

17. A display apparatus, comprising a memory, a processor, and a computer program stored in the memory and executable on the processor, wherein the processor is configured to execute the computer program to implement steps of the method according to claim 3.

18. A computer-readable storage medium, storing a computer program, wherein the computer program is executed by a processor to implement steps of the method according to claim 1.

19. A computer-readable storage medium, storing a computer program, wherein the computer program is executed by a processor to implement steps of the method according to claim 2.

20. A computer-readable storage medium, storing a computer program, wherein the computer program is executed by a processor to implement steps of the method according to claim 3.
